(19) United States
(12) Patent Application Publication
(10) Pub. No.: US 2016/0381136 A1
(43) Pub. Date: Dec. 29, 2016

(54) SYSTEM, METHOD, AND COMPUTER PROGRAM FOR PROVIDING REST SERVICES TO FINE-GRAINED RESOURCES BASED ON A RESOURCE-ORIENTED NETWORK

(71) Applicant: Futurewei Technologies, Inc., Plano, TX (US)

(72) Inventors: Li Li, Bridgewater, NJ (US); Wu Chou, Basking Ridge, NJ (US)

(21) Appl. No.: 14/749,453

(22) Filed: Jun. 24, 2015

(51) Int. Cl. H04L 29/08

(52) U.S. Cl. CPC H04L 67/1074; H04L 67/32

(57) ABSTRACT

A system, method, and computer program product are provided for accessing resources based on a resource-oriented network. In use, a request is received for a first resource. In response to receipt of the request for the first resource, a resource-oriented network mapping is identified. A second resource is identified based on the resource-oriented network mapping. Such second resource is accessed for generating a response.

### FIELD OF THE INVENTION

The present invention relates to Cloud resource management, and more particularly to providing representational state transfer (REST) services to fine-grained resource management.

### BACKGROUND

Typical cloud computing, for the most part, is based on virtual machine (VM) technologies, an infrastructure that a cloud provider offers to its clients in the form of VM images that can have different sizes of resources. Once the size of a VM is chosen, it has a fixed amount of processor, memory, and input/output capacities that cannot readily be changed easily by the client. A VM has a guest operating system (OS) that may or may not be the same as the host OS on the physical machine, and the translation between the guest OS and host OS is typically provided by a hypervisor

Although many current cloud computing platforms are still based on VMs running on hypervisors, there are two trends toward a more flexible and efficient cloud computing paradigm. One trend is a Resource-as-a-Service (RaaS) based cloud, where the fine-grained resources can be rented at short time intervals. The other one is a container-based cloud, where the lightweight containers replace the VMs. Both trends, however, require a more flexible and efficient resource management framework to address the increased demands for scalability, heterogeneity, flexibility, deployment density, and/or efficiency.

There is thus a need for addressing these and/or other issues associated with the prior art.

### SUMMARY

A system is provided for accessing resources based on a resource-oriented network (RON). Included is at least one processor configured for receiving a request for a first resource. In response to receipt of the request for the first resource, the at least one processor identifies a RON mapping. Further, a second resource is identified, based on the RON mapping. Still yet, the at least one processor accesses the second resource for generating a response.

A computer program product is also provided for accessing resources based on a RON. Included is code for receiving a request for a first resource. In response to receipt of the request for the first resource, code identifies a RON mapping. Further, a second resource is identified, based on the RON mapping. Still yet, code accesses the second resource for generating a response.

Still yet, a method is provided for accessing resources based on a RON. In use, a request is received for a first resource. In response to receipt of the request for the first resource, a RON mapping is identified. A second resource is identified based on the RON mapping. Such second resource is accessed for generating a response.

### BRIEF DESCRIPTION OF THE DRAWINGS

FIG. 1 illustrates a method for accessing resources based on a resource-oriented network (RON), in accordance with one embodiment.

FIG. 2 illustrates an architecture for allowing access to a plurality of REST services that are defined by a RON, in accordance with one embodiment.

FIG. 3 illustrates a system for accessing resources based on a RON, in accordance with one embodiment.

FIG. 4A illustrates a RON model, in accordance with one embodiment.

FIG. 4B illustrates a RON model, in accordance with one embodiment.

FIG. 5 illustrates an S-RON for a multi-cgroup hierarchy, in accordance with one embodiment.

FIG. 6 illustrates an S-RON for a unified cgroup hierarchy, in accordance with one embodiment.

FIG. 7 illustrates a T-RON for a multi-cgroup hierarchy, in accordance with one embodiment.

FIG. 8 illustrates a T-RON for a unified cgroup hierarchy, in accordance with one embodiment.

FIG. 9 illustrates a C-RON, in accordance with one embodiment.

FIG. 10 illustrates a J-RON, in accordance with one embodiment.

FIG. 11 illustrates an architecture where a container factory dynamically configures RBAC databases used by authorize users, in accordance with one embodiment.

FIG. 12 illustrates a technique for scaling a job and cluster RON with hierarchy, in accordance with one embodiment.

FIG. 13 illustrates a technique for synchronizing a high-level RON with a low-level RON, in accordance with one embodiment.

FIGS. 14 and 15 show exemplary addition and subtraction RONs, in accordance with various embodiments.

FIG. 16 shows an exemplary RON addition algorithm, in accordance with another embodiment.

FIG. 17 shows an exemplary RON subtraction algorithm, in accordance with another embodiment.

FIG. 18 illustrates a network architecture, in accordance with one possible embodiment.

FIG. 19 illustrates an exemplary system, in accordance with one embodiment.

### DETAILED DESCRIPTION

A system, method, and computer program product are provided for accessing resources based on a resource-oriented network (RON). In use, a request is received for a first resource. In response to receipt of the request for the first resource, a RON mapping is identified. A second resource is identified based on the RON mapping. Such second resource is accessed for generating a response, based on the access to the second resource.

Various embodiments will now be described that incorporate the aforementioned features. For example, in some optional embodiments, the RON mapping may allow an abstraction of an underlying system that includes the second resource, and further enable requests that are intended to leverage the second resource without necessarily calling specifically on the second resource. Instead, such requests are capable of calling higher-level services. Further, in some embodiments, the RON mapping may enable satisfaction of the requests irrespective of changes in the underlying system which may be common in some systems (e.g. open source, etc.). To accommodate such changes, the resource-oriented network mapping may be capable of being synchronized based on changes in the underlying system.

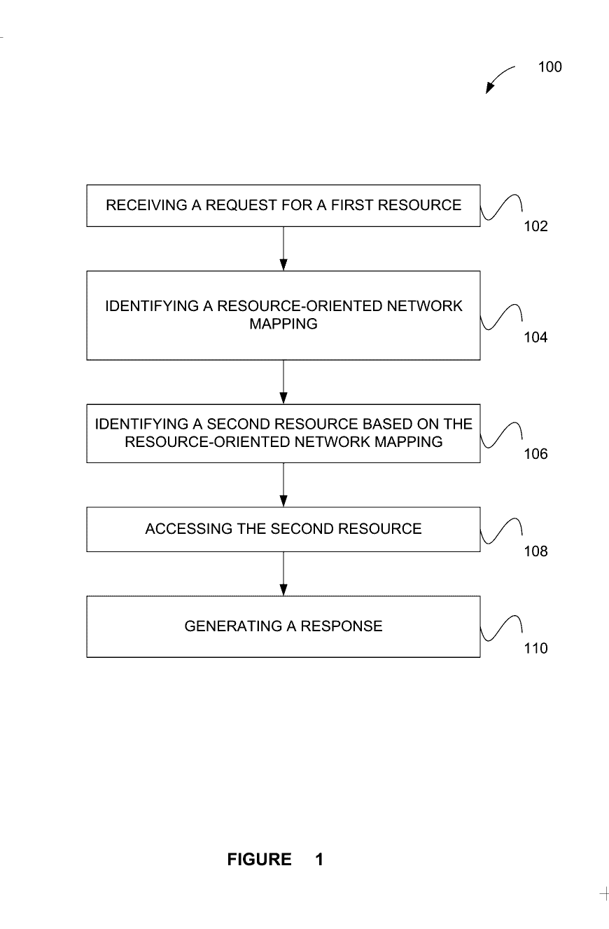

FIG. 1 illustrates a method 100 for accessing resources based on a RON, in accordance with one embodiment. As shown, in operation 102, a request is received for a first resource. In the context of the present description, such first resource may include any resource that is capable of being requested in operation 102. For example, in one embodiment, the first resource may include a representational state transfer (REST) resource. Of course, other resources are contemplated that adhere to other software architectures including guidelines and/or best practices for creating scalable web services or the like. Still yet, in various other embodiments, the first resource may include a task, a job, a server, a cluster, and/or any other resource, for that matter.

In response to receipt of the request for the first resource, a RON mapping is identified. See operation 104. In the context of the present description, such RON mapping may include any data structure that is capable of allowing at least one second resource to be identified based on a request involving at least one first resource. For example, in one embodiment, this may be accomplished by the RON mapping serving to map the first resource(s) to second resource(s).

In one embodiment, the first resource(s) may reside at a first layer and the second resource(s) at a second layer. For example, in one embodiment, the first layer may include a services layer (e.g. REST resource layer including the aforementioned tasks, jobs, servers, and/or clusters, etc.), while the second layer may include a component layer [e.g. a control group (cgroup) resource layer including processor, memory, storage, and/or network component, etc.].

As will set be set forth during the description of subsequent embodiments, the RON may also take the form of a resource-oriented tree (ROT), and the request of operation 102 may follow a model involving the RON/ROT. In such embodiment, the ROT may be equipped with at least one parent node and at least one child node. As will be described later, the ROT may serve to decouple a data plane, a control plane, and a representation plane, in some embodiments. In such embodiments, the data plane may include the second resource, the control plane may include the first resource, and the representation plane may include a hypertext- or a hyperlink-based relation among a plurality of the first resources. For the purposes of the remaining description, when the term RON is utilized, it should be noted that a ROT is contemplated as an example of such RON.

Thereafter, in operation 106, one or more second resources is identified based on the resource-oriented network mapping. Further, the second resource may be accessed. See operation 108. To this end, as indicated in operation 110, a response is generated, based on the accessing of the second resource.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

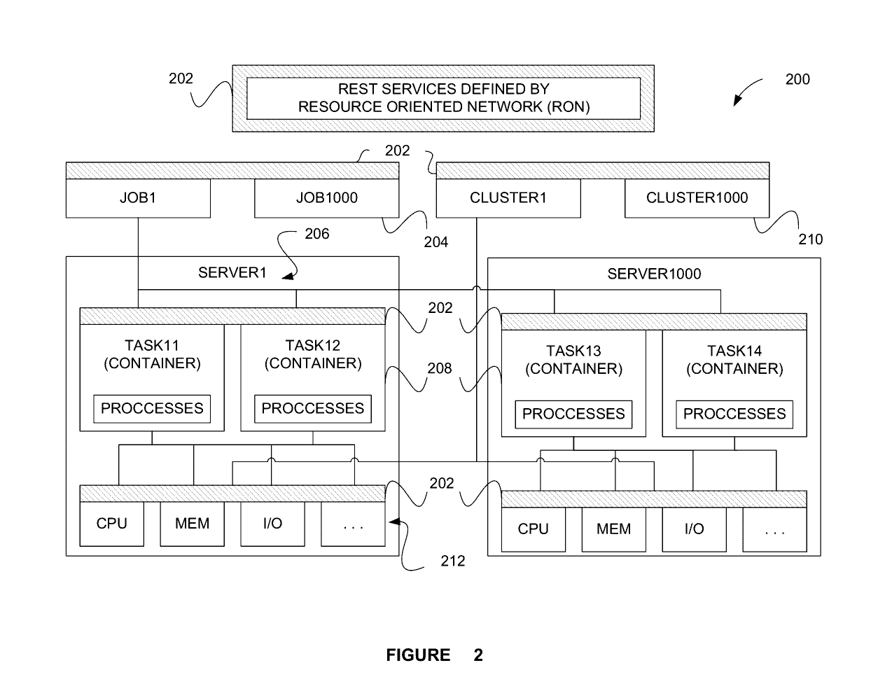

FIG. 2 illustrates an architecture 200 for allowing access to a plurality of REST services that are defined by a RON, in accordance with one embodiment. As an option, the system 200 may be implemented in the context of any one or more of the embodiments set forth in any previous and/or subsequent figure(s) and/or description thereof. Of course, however, the system 200 may be implemented in the context of any desired environment.

As shown, a REST services layer 202 is defined by a RON (e.g. ROT, etc.). Such REST services layer 202 includes jobs 204, servers 206, tasks 208, and/or clusters 210. As further shown, REST services layer 202 is further mapped to resources 212 of an underlying system including processor, memory, I/O, etc. During use, some of the higher level RON nodes (e.g. jobs 204, clusters 210, etc.) may depend on some of the lower-level RON nodes (e.g. servers 206, tasks 208, etc.). More information regarding such dependency will be set forth in greater detail during reference to subsequent figures.

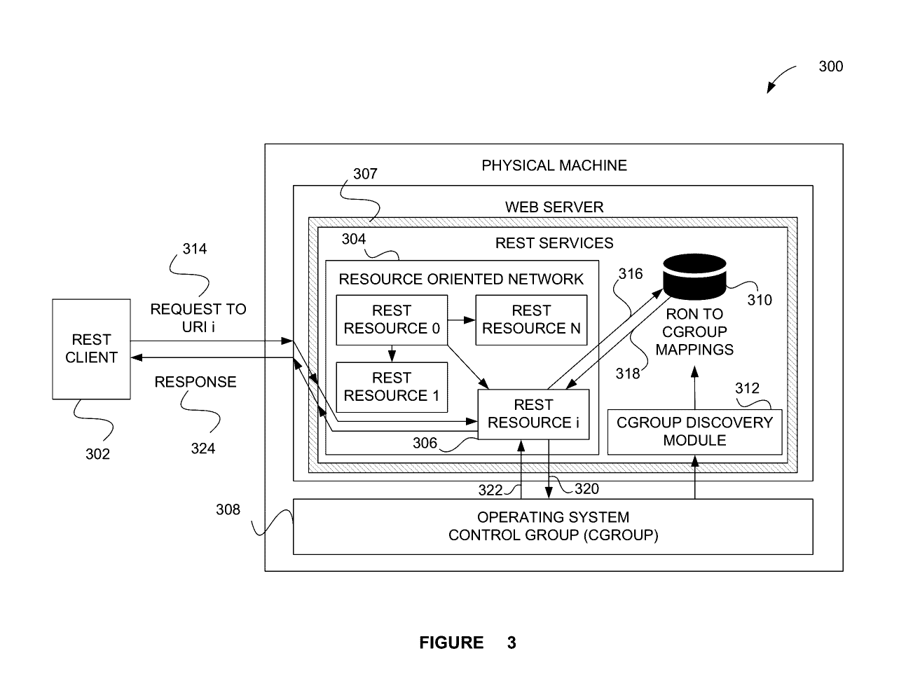

FIG. 3 illustrates a system 300 for accessing resources based on a RON, in accordance with one embodiment. As an option, the system 300 may be implemented in the context of any one or more of the embodiments set forth in any previous and/or subsequent figure(s) and/or description thereof. Of course, however, the system 300 may be implemented in the context of any desired environment.

Included is a client 302 that is capable of issuing requests to a RON 304 that includes a plurality of REST resources 306 of a REST services layer 307 (e.g. REST services layer 202 of FIG. 2, etc.). As shown, the REST resources 306 are connected via a plurality of hyperlinks. To service such requests, the RON 304 has access to an underlying cgroup system 308. Further, to map the requests for REST services to the resources of the underlying cgroup system 308, a mapping 310 is provided.

Prior to use, the mapping 310 may be built using a discovery module 312. Specifically, the discovery module 312 may start by scanning a file system of the underlying cgroup system 308, for the purpose of discovering resources of the underlying cgroup system 308. Thereafter, the discovery module 312 populates the mapping 310 with the discovered resources.

Thus, during use, the client 302 may, in operation 314, direct requests to one or more of the REST resources 306. As an option, each request may have an associated uniform resource identifier (URI). Specifically, the requests may be directed to the URI of the intended REST resources 306.

Upon receipt of such request, the corresponding REST resource 306 queries the mapping 310, in operation 316, for identifying the resources of the underlying cgroup system 308 required for satisfying the request. Identification of such resources of the underlying cgroup system 308 are then returned in operation 318.

By this design, the REST resource 306 may access the underlying cgroup system 308 in operation 320 which, in turn, generates and returns a response to the original request. See operation 322. Such response is then packaged and returned to the client 302, in operation 324, in satisfaction of the request.

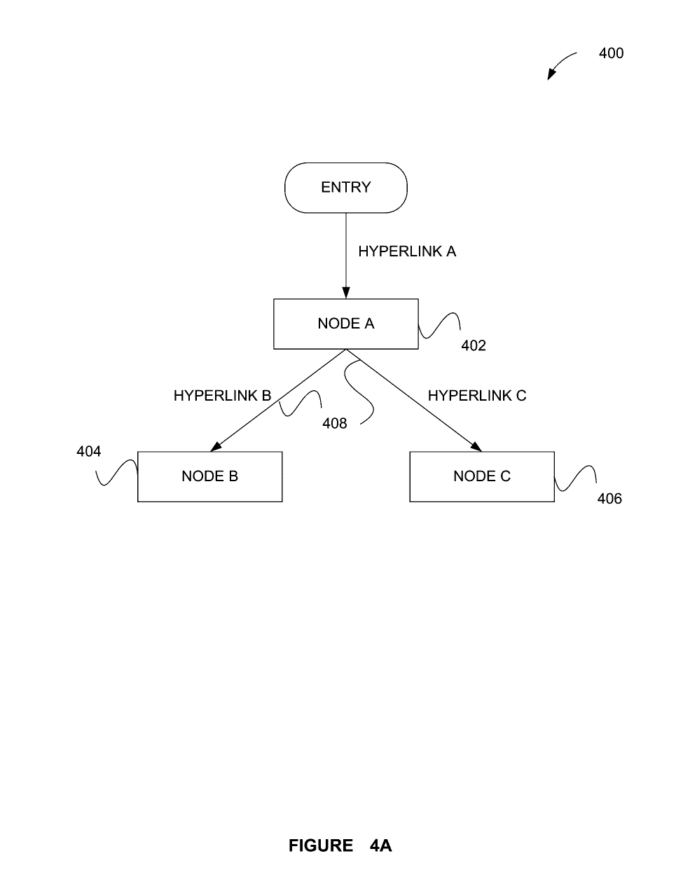

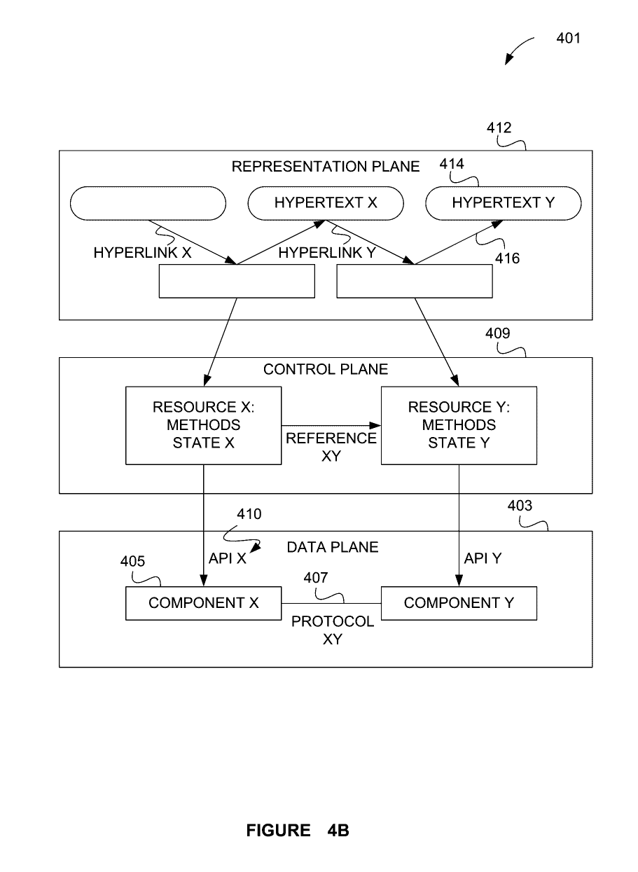

FIG. 4A illustrates a RON model 400, in accordance with one embodiment. As an option, the RON model 400 may be implemented in the context of any one or more of the embodiments set forth in any previous and/or subsequent figure(s) and/or description thereof. Of course, however, the RON model 400 may be implemented in the context of any desired environment.

As shown, the RON model 400 includes a plurality of RON nodes 402, 404, 406 that are interconnected via hyperlinks 408. Each of such RON nodes 402, 404, 406 represents a REST resource that provides services to a client. Such RON nodes 402, 404, 406 thus each represent one of three types of resources: a group of processes, a control module that controls the behavior of a group, and/or a parameter of a control module.

As mentioned earlier, the RON model 400 may take the form of a tree and, in one embodiment, nomenclature may be provided, where, for node x: x.name contains the name of x; x.children contains the children of x; x.parent contains the parent of x; x.rc contains the reference count of x, which counts the number of low-level RON that references x.

FIG. 4B illustrates a RON model 401, in accordance with one embodiment. As an option, the RON model 401 may be implemented in the context of any one or more of the embodiments set forth in any previous and/or subsequent figure(s) and/or description thereof. Of course, however, the RON model 401 may be implemented in the context of any desired environment.

The RON of the present REST service framework enables abstraction and normalization of the access to heterogeneous cloud components and resources at any application-defined granularity. As mentioned earlier, the RON model 401 includes a plurality of planes (e.g. layers, etc.). Specifically, as shown in FIG. 4B, a data plane 403 is provided as the lowest plane that includes heterogeneous cloud hardware and software components 405, such as CPU, memory, storage, network, switches, routers, tasks, jobs, servers, clusters, etc., that communicate in a variety of protocols 407.

Further included is a control plane 409 that constitutes a middle plane including REST resources implemented in any programming language that exposes uniform interfaces and interacts with the data plane 403 through respective application program interfaces (APIs) 410. Still yet, a representation plane 412 is provided which constitutes a top plane including hypertexts 414 that represent the states and relations of the REST resources in the control plane 409, while the structures and relationships of the hypertexts 414 can be described by a REST chart.

In one embodiment, such REST chart may include a Petri-Net based modeling framework to describe the REST services. One particular feature of such REST chart is an ability to combine static and dynamic aspects of a REST API into one unified and coherent model, in which the resource interactions may be driven by the hypertext 414 and hyperlinks 416. In use, the interactions between a REST client and a REST API over a network protocol are modeled by tokens moving around the Petri-Net defined by the REST chart.

The separation of the control plane 409 and data plane 403 can be logical if the REST resources are part of the components. To speed up the RON development process and reduce potential inconsistencies between the REST API documentation and implementation, a toolkit (e.g. JAVA toolkit, etc.) may be used to automatically generate JAVA implementations of a REST API in the control plane 409 from a REST chart.

In use, the REST Chart may be loaded into an RC-JAVA, which generates JAVA message classes using JAXB from XML schemas and JAX-RS compliant JAVA resource classes from the REST chart. A developer may then implement the JAVA methods in the resource classes to connect them with the data plane APIs 410. Finally, a developer may use the tool to compile, package, and deploy the artifacts into a server.

At the runtime, the hyperlinks 416 in the representation plane 412 may be used to control the relationships between the REST resources in the control plane 409, which, in turn, controls the relationships between the components 405 in the data plane 403, using, for example a categorical link. In a reverse direction, the data plane 403 may notify changes to the control plane 409 and representation plane 412.

Thus, in different embodiments, the RON model 401 may help address the issues of resource-as-a-service (RaaS) cloud architectures in a variety of possible ways. For example, the RON model 401 may be scalable as the resources in both the control plane 409 and the data plane 403 are distributed, without requiring a central control. Further, regarding heterogeneity, the representation plane 412 and the control plane 409 may abstract and normalize the heterogeneous components 405 in the data plane 403 as uniform REST services. Changes in the data plane 403 can thus only affect the control plane 409 locally. This is because, when a resource in the control plane 409 changes its state, such resource will not affect the resources that connect to it. Still yet, with respect to efficiency, the control plane 409 is not necessarily involved in the communication within the data plane 403, and it is possible to use more efficient protocols and message formats, such as HTTP 2.0 and JAVAScript object notation (JSON), to improve performance of the control plane 408.

With the current approach, RON model 401 may be used to design and implement REST APIs to dynamically control the capacity of containers (e.g. Docker containers, etc.) based on cgroups which may have different structures in different Linux systems. Changes to the cgroup hierarchy have an effect of completely changing a current cgroup structure. To make the RON model 401 independent of these differences and changes, while providing full access to the functions offered by a cgroup API, resource management functions may be partitioned into 4 types of RONs, based on the concepts of task, job, server, and cluster. From a cloud provider's perspective, any user application is treated as a job, which can contain many tasks. For example, a 3-tier Web application may include a job that contains 3 types of tasks: web servers, application servers, and database servers, all running in distributed containers. Physical servers in a datacenter are usually grouped into clusters to reduce management complexity.

While any types of RONs are contemplated, four exemplary types of RONs will now be described. First, a task RON (T-RON) exposes a REST API for cloud users and providers to dynamically control the capacity of a running user task (e.g. Docker container, etc.). Further, a job RON (J-RON) exposes a REST API for cloud users and providers to aggregate and orchestrate the capacities of its distributed tasks through a T-RON. Still yet, a server RON (S-RON) exposes a REST API for cloud providers to control the capacity of a physical server through the cgroup API. Even still, a cluster RON (C-RON) exposes a REST API for cloud providers to aggregate and orchestrate the capacities of its distributed servers through S-RON.

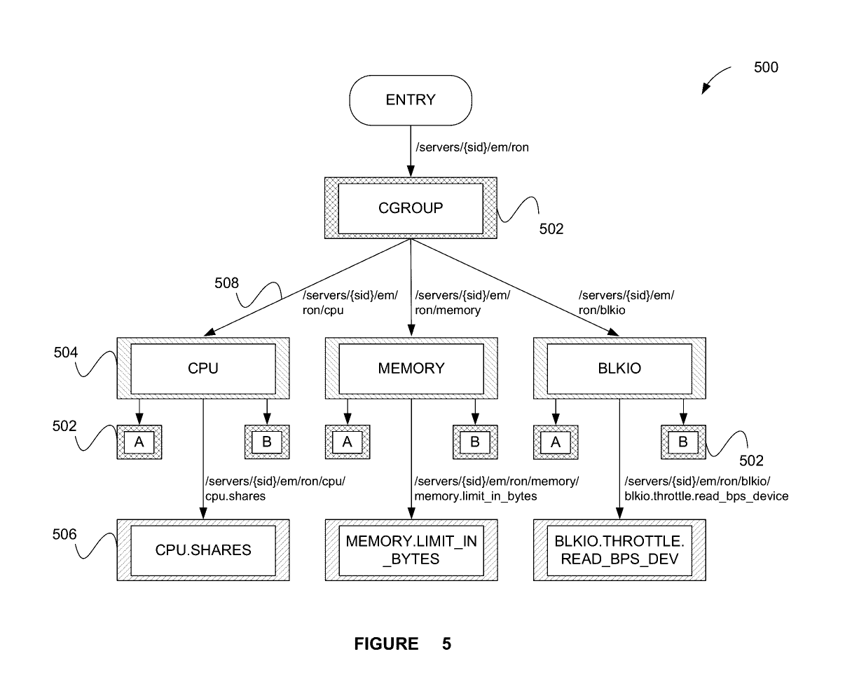

FIG. 5 illustrates an S-RON 500 for a multi-cgroup hierarchy, in accordance with one embodiment. As an option, the S-RON 500 may be implemented in the context of any one or more of the embodiments set forth in any previous and/or subsequent figure(s) and/or description thereof. Of course, however, the S-RON 500 be implemented in the context of any desired environment.

As shown in FIG. 5, the S-RON 500 may include group nodes 502 for controlling a group of processes, and control nodes 504 for controlling a behavior of group(s) associated with the group nodes 502 via CPU, memory, black I/O (i.e. storage I/O, etc.), etc. Still yet, the S-RON 500 may include parameter nodes 506 that may be used to control the control nodes 504 via CPU shares, memory parameters (e.g. byte limit, etc.), as illustrated. Still yet, the various nodes of the S-RON 500 may be traversed via the hyperlinks 508 shown.

The S-RON 500 is modeled closely after a cgroup hierarchy to provide full access to its functionality, whereas the other RONs adopt different models from the cgroup hierarchy, in order to provide task-, job- and cluster-centric controls, and isolate underlying cgroup differences and evolutions from the clients. The S-RON 500 provides control to the fine-grained resources of processes (e.g. Linux, etc.) on a server with the REST API described in Table 1.

TABLE 1

| URI template | method | action |
|---|---|---|
| /servers/{sid}/em/ron | GET | retrieve all cgroups |
| .../{cgroup} | GET | retrieve a particular |
| | | cgroup |
| | PUT | update all cgroup |
| | | parameters |
| .../{cgroup}/{parameter} | GET | retrieve a cgroup |
| | | parameter |
| | PUT | update a cgroup |
| | | parameter |

Specifically, Table 1 illustrates the actions that may be initiated by a client via the appropriate method and URI (which each corresponds to an associated node). Further, the various nodes (and associated finer-granularity of services) may be discovered via the aforementioned hyperlinks 508. For instance, in one example of use, the REST API of the S-RON 500 can be used to control the CPU shares, memory limit, and I/O rate of the processes in the relevant container using the URIs that are shown in FIG. 5.

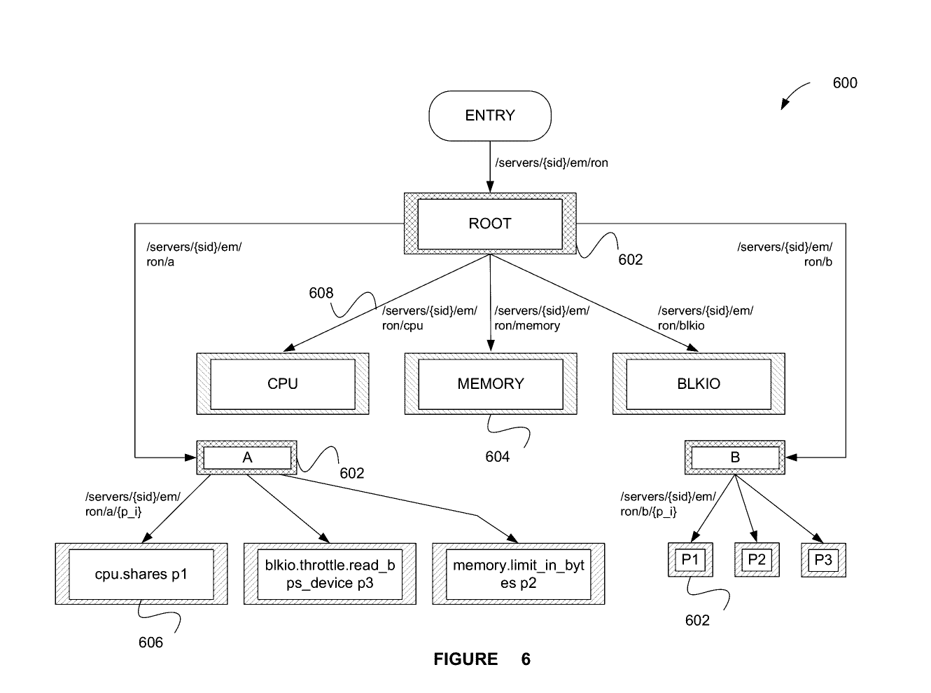

FIG. 6 illustrates an S-RON 600 for a unified cgroup hierarchy, in accordance with one embodiment. As an option, the S-RON 600 may be implemented in the context of any one or more of the embodiments set forth in any previous and/or subsequent figure(s) and/or description thereof. Of course, however, the S-RON 600 may be implemented in the context of any desired environment.

As shown in FIG. 6, similar to the S-RON 500 of FIG. 5, the S-RON 600 may include group nodes 602 for controlling a group of processes, and control nodes 604 for controlling a behavior of group(s) associated with the group nodes 602 via CPU, memory, black I/O, etc. Still yet, the S-RON 600 may include parameter nodes 606 that may be used to control the control nodes 604 via CPU shares, memory parameters (e.g. byte limit, etc.), as illustrated. Still yet, the various nodes of the S-RON 600 may be traversed via the hyperlinks 608 shown.

As shown, the REST services may remain the same and the hyperlinks may remain the same, as compared to the S-RON 500 for the multi-group hierarchy of FIG. 5. However, as illustrated, the relations between the control nodes 604 and the group nodes 602 of the S-RON 600 for a unified cgroup hierarchy may be different. To this end, the S-RON 600 may be equipped to accommodate a significant change in the underlying cgroup structure from the multi-hierarchy to the unified hierarchy, by linking the various nodes in a dynamically-changing manner.

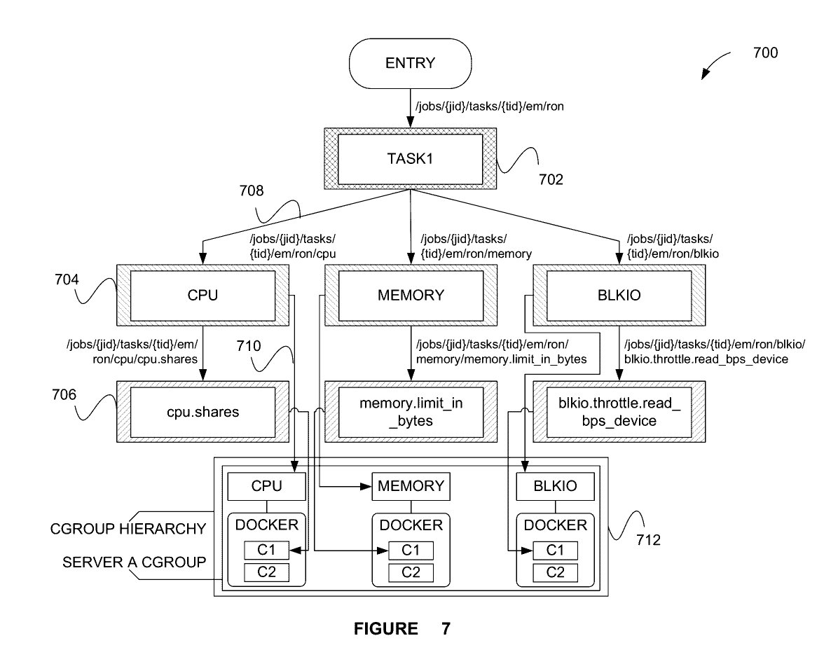

FIG. 7 illustrates a T-RON 700 for a multi-cgroup hierarchy, in accordance with one embodiment. As an option, the T-RON 700 may be implemented in the context of any one or more of the embodiments set forth in any previous and/or subsequent figure(s) and/or description thereof. Of course, however, the T-RON 700 may be implemented in the context of any desired environment.

As shown in FIG. 7, similar to the S-RON 500/600 of FIG. 5/6, the T-RON 700 may include group nodes 702 for controlling a group of processes, and control nodes 704 for controlling a behavior of group(s) associated with the group nodes 702 via CPU, memory, black I/O, etc. Still yet, the T-RON 700 may include parameter nodes 706 that may be used to control the control nodes 704 via CPU shares, memory parameters (e.g. byte limit, etc.), as illustrated. Still yet, the various nodes of the T-RON 700 may be traversed via the hyperlinks 708 shown. Also shown in FIG. 7 is a cgroup mapping 710 between the T-RON 700 and an associated cgroup 712.

In use, each physical server that runs some tasks and may have one S-RON and some T-RONs 700 on it. As shown, the S-RON and T-RON 700 are mapped to the cgroups in a Server A, where the cgroup hierarchy is depicted as nested boxes. Unlike the process-centric S-RON, the T-RON 700 provides a task-centric view on resource management, where the fine-grained resources (e.g. processor, memory, input/output, etc.) of a task is represented as interconnected REST resources. A REST API of the T-RON 700 is summarized in Table 2, where {control} represents a type of fine-grained resource allocated to the task.

TABLE 2

| URI template | method | comment |
|---|---|---|
| /jobs/{jid}/tasks/{tid}/em/ron | GET | retrieve root |
| | | cgroup |
| .../{control} | GET | retrieve all |
| | | control |
| | | parameters |
| | PUT | update all |
| | | control |
| | | parameters |
| .../{control}/{parameter} | GET | retrieve a |
| | | control |
| | | parameter |
| | PUT | update a |
| | | control |
| | | parameter |

In use, the T-RON 700 automatically discovers all the tasks from the cgroup hierarchy on the server and builds a control model that maps the URIs in Table 2 to the cgroup nodes, as illustrated in FIG. 7. Upon receiving a request, the REST API calls the appropriate cgroup API based on the control model. For example, to access the CPU shares of task 2 of job 1, it can use URI:/jobs/1/tasks/2/cpu/cpu.shares, which is mapped by the model to a cgroup node that may differ on different Linux systems. As the result, the T-RON 700 hides cgroup structure from the clients while providing direct access to the cgroup controls. This may be particularly beneficial when Linux cgroup undergoes major changes.

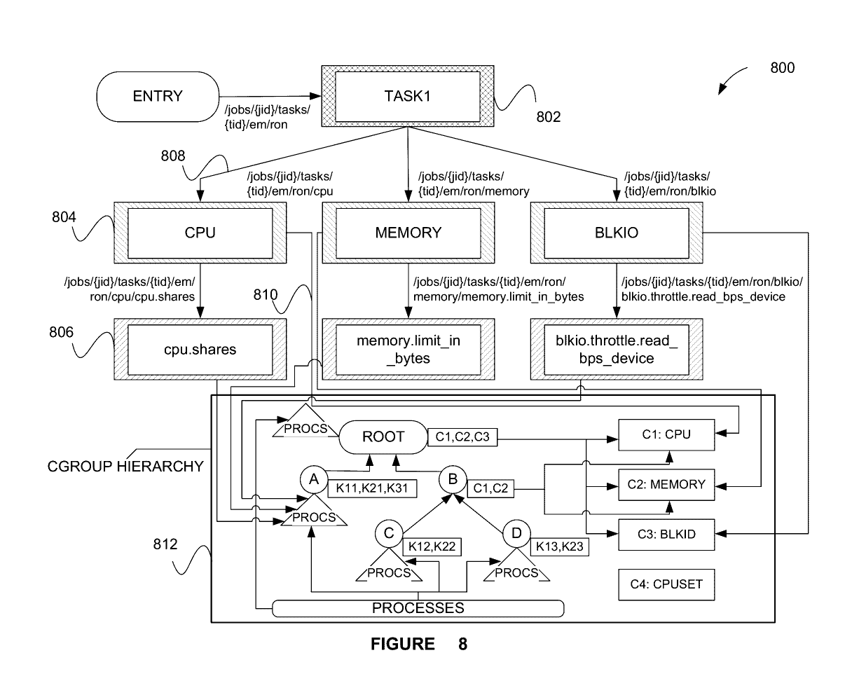

FIG. 8 illustrates a T-RON 800 for a unified cgroup hierarchy, in accordance with one embodiment. As an option, the T-RON 800 may be implemented in the context of any one or more of the embodiments set forth in any previous and/or subsequent figure(s) and/or description thereof. Of course, however, the T-RON 800 may be implemented in the context of any desired environment.

As shown in FIG. 8, similar to the T-RON 700 of FIG. 7, the T-RON 800 may include group nodes 802 for controlling a group of processes, and control nodes 804 for controlling a behavior of group(s) associated with the group nodes 802 via CPU, memory, black I/O, etc. Still yet, the T-RON 800 may include parameter nodes 806 that may be used to control the control nodes 804 via CPU shares, memory parameters (e.g. byte limit, etc.), as illustrated. Still yet, the various nodes of the T-RON 800 may be traversed via the hyperlinks 808 shown.

With continued reference to FIG. 8, the REST services and RON structure for the unified cgroup hierarchy may remain the same, as compared to the T-RON 700 for the multi-group hierarchy of FIG. 7. However, as illustrated, the mappings 810 between the RON and cgroup of the T-RON 800 for a changed unified cgroup hierarchy 812 may be different.

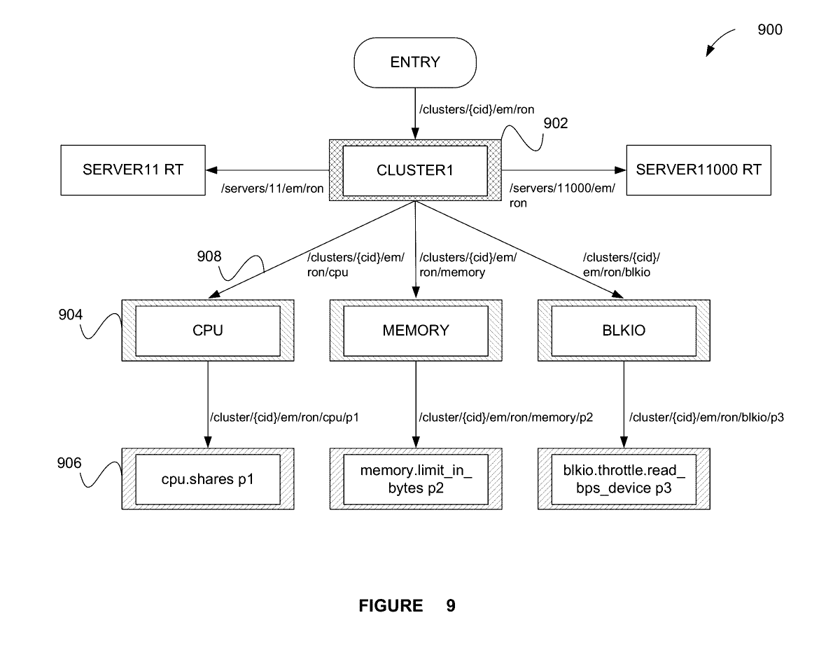

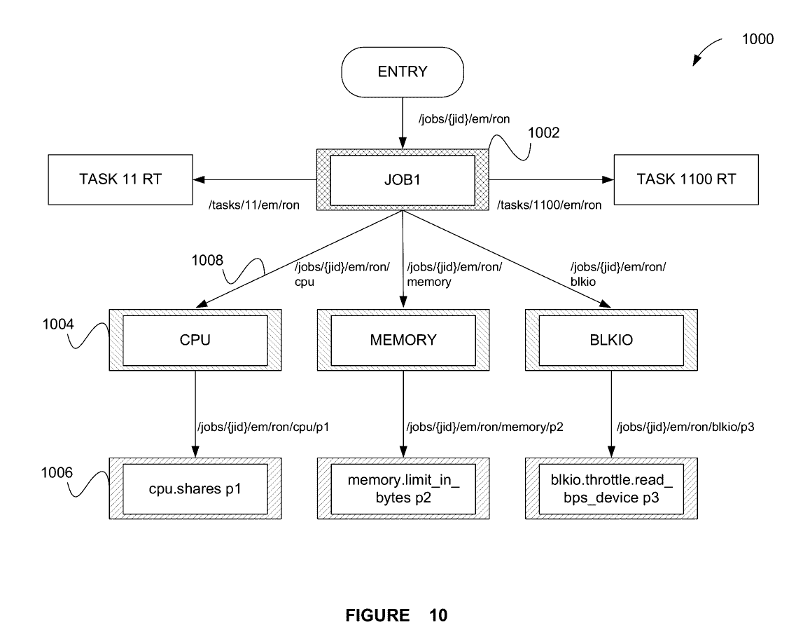

FIG. 9 illustrates a C-RON 900, in accordance with one embodiment. FIG. 10 illustrates a J-RON 1000, in accordance with one embodiment. As an option, the C-RON 900 and/or J-RON 1000 may be implemented in the context of any one or more of the embodiments set forth in any previous and/or subsequent figure(s) and/or description thereof. Of course, however, the C-RON 900 and/or J-RON 1000 may be implemented in the context of any desired environment.

As shown in FIGS. 9-10, the C-RON 900/J-RON 1000 may include group nodes 902 for controlling a group of processes, and control nodes 904/1004 for controlling a behavior of group(s) associated with the group nodes 902/1002 via CPU, memory, black I/O, etc. Still yet, the C-RON 900/J-RON 1000 may include parameter nodes 906/1006 that may be used to control the control nodes 904/1004 via CPU shares, memory parameters (e.g. byte limit, etc.), as illustrated. Still yet, the various nodes of the C-RON 900/J-RON 1000 may be traversed via the hyperlinks 908/1008 shown.

In use, the J-RON 1000 serves two purposes. First, the J-RON 1000 provides hyperlinks to the distributed T-RONs. Further, the J-RON 1000 provides a central control point to the distributed T-RONs. Similarly, the C-RON 900 provides hyperlinks as well as a central control point to the distributed S-RONs. This design allows the clients to control the tasks (servers) of a job (cluster), as a whole, or individually with the layered REST APIs.

The REST APIs of J-RON 1000 and C-RON 900 are summarized in Table 3 and Table 4 respectively.

TABLE 3

| URI template | method | action |
|---|---|---|
| /jobs/{jid}/em/ron | GET | retrieve |
| | | hyperlinks to task |
| | | RONs and |
| | | aggregated |
| | | controls |
| Table 2 row 1, column 1 | GET | Table 2 row 1, |
| | | column 3 |
| .../{control} | GET | retrieve a |
| | | particular control |
| .../{control}/{parameter} | GET | retrieve a control |
| | | parameter |

TABLE 4

| URI template | method | action |
|---|---|---|
| /clusters/{cid}/em/ron | GET | retrieve hyperlinks to |
| | | server RONs and |
| | | aggregated controls |
| Table 1 row 1, column 1 | GET | Table 1 row 1, |
| | | column 3 |
| .../{control} | GET | retrieve a particular |
| | | control |
| .../{control}/{parameter} | GET | retrieve a control |
| | | parameter |

As shown, the two REST APIs are very similar to each other, and they are also similar to the T-RON REST API in Table 2, except the entry URIs. This similarity gives the REST APIs a familiar look-and-feel for users on one hand, and makes the REST APIs easy to create and maintain for developers on the other hand. These benefits are the results of adopting a common RON model for REST API design.

Each cgroup parameter p of the J-RON 1000 (C-RON 900) aggregates the values of the corresponding parameters in the T-RON (S-RON) into a range p=(max,min), such that the clients knows the range of possible resources in the J-RON 1000 (C-RON 900). The J-RON 1000 (C-RON 900) can also run workflows to control multiple fine-grained resources, e.g., simultaneously increase the CPU usage shares of containers 11 and 12.

To discover the T-RONs of a job, a REST client may follow the hyperlinks provided by the J-RON 1000. See Table 3, row 2. A REST client can reach any S-RON of a cluster from the C-RON 900 in a similar way. See Table 4, row 2. The layered structure of the RON makes it scalable and extensible, but it may increase the resource discovery cost for the REST services. However, the cost is amortized as the visits to the same URI increase, and this amortization can be measured by the utility ratio of a URI, defined as V/(D+V), where D is the interactions needed to discover a REST resource URI, and V is the number of subsequent visits to the URI.

For example, starting from the J-RON 1000 entry URI, a client may take D=1+3=4 interactions to discover a control parameter at a T-RON for the first time. If the client caches the URI and visits it directly V=9 times, the utility ratio is 10/(4+10)=71%, and it increases to 83% with V=20 visits. Given the frequent changes in workloads, a resource management client is likely to frequently revisit a URI, which will increase the utility ratio. To eliminate the discovery cost, some REST APIs expose fixed URis that do not require discovery, such that D=0 and the utility ratios are 1 for all the URIs. Although this approach achieves a maximum utility ratio, it sacrifices the flexibility of a REST API, as it breaks the clients whenever it changes or updates its URIs. In large scale distributed systems, this may happen very often as resources are added and deleted dynamically. In other embodiments, differential caches may be used that can balance the efficiency and URI utility ratio and maintain the full flexibility of REST services.

The J-RON 1000 is layered on top of the T-RON, while the C-RON 900 is layered on top of S-RON, to reuse the low-level REST APIs. However, such layering of RONs does not necessarily sacrifice efficiency, as in conventional layered systems. This is because REST resources in different RONs are connected and a REST client can invoke REST resources in any RON directly after they are discovered through hyperlinks.

Generally speaking, a REST API permits two kinds of actions, namely an invoke action which invokes a REST API as a client; and a manage action which controls the lifecycle of a REST API, including deploy, start, stop, pause, and resume. Different subjects in a cloud framework may be granted with different action permissions to a RON, and these permissions are summarized in Table 5.

TABLE 5

| | | | | |
|---|---|---|---|---|
| access | J-RON | T-RON | S-RON | C-RON |

| | | |
|---|---|---|
| User | invoke | invoke |

| | | | | |
|---|---|---|---|---|
| Provider | manage | manage | invoke | invoke |
| | | | manage | manage |

This policy permits cloud users to use the J-RON 1000 and T-RON REST APIs, but not necessarily manage them. The management action is left to the cloud providers. The S-RON and the C-RON 900 are infrastructure resources which are not accessible to anyone but the cloud provider. Under this general policy, it is ensured that each user can only access the J-RON 1000 associated with their jobs and T-RON associated with their tasks. If, for example, user u1 owns job j1 and its tasks, and user u2 owns job j2 and its tasks, each user can only access their own namespaces shown in Table 6, according to the namespace templates in Table 2 and Table 3.

TABLE 6

| User | namespaces |
|---|---|
| u1 | /jobs/{j1}/em/ron |
| | /jobs/{j1}/tasks/{tid}/em/ron |
| u2 | /jobs/{j2}/em/ron |
| | /jobs/{j2}/tasks/{tid}/em/ron |

There are different access control mechanisms to enforce the namespace policy. Since some frameworks (e.g. Tomcat, etc.) supports a role-based access control (RBAC) model, such model may be adopted for access control. The RBAC model serves to map the roles (R) to the namespaces (N) with R→N, and map the users (U) to the roles with U→R to decide which user can access which namespaces (U→N).

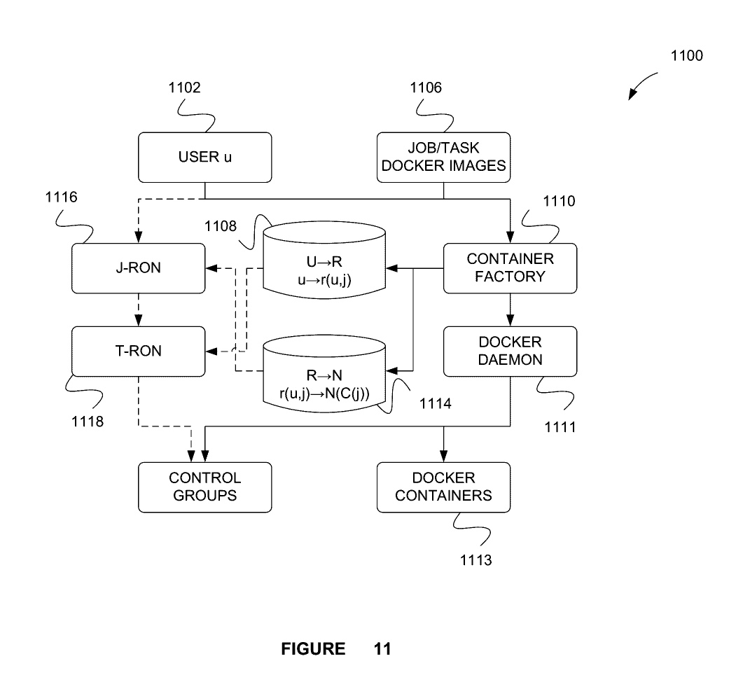

FIG. 11 illustrates an architecture 1100 where a container factory dynamically configures RBAC databases used by authorize users, in accordance with one embodiment. As an option, the architecture 1100 may be implemented in the context of any one or more of the embodiments set forth in any previous and/or subsequent figure(s) and/or description thereof. Of course, however, the architecture 1100 may be implemented in the context of any desired environment.

As shown in FIG. 11, RBAC databases are set up by the solid arrows, as follows. First, a factory 1110 accepts commands from a user u 1102 to create task containers for job j from task images 1106. The factory 1110 then authenticates the user u 1102, creates a role r(u,j) for u, and saves u→r(u,j) in a database U→R 1108. The factory 1110 then asks a daemon 1111 (e.g. Docker Daemon, etc.) to launch the containers 1113 (e.g. Docker containers C(j), etc.) for job j. The factory 1110 then assigns the namespaces N(C(j)) to r(u,j) and save r(u,j)→N(C(j)) in the R→N database 1114. Examples of N(C(j))) are set forth in Table 6.

When the user u 1102 adds a new job j, a new role r(u,j) is created for job j and its tasks. When a job j is removed, the corresponding role r(u,j) is also removed. However, when the user u 1102 adds or removes tasks for job j, no change to roles is needed and there is only a need to change the namespaces N(C(j)) associated with job j. When a task container migrates to a new server and assumes a new identity, it is treated as removing the old task and adding a new one.

The RBAC databases are accessed by the J-RON 1116 and the T-RON 1118 to control client access, as shown by the dashed arrows in FIG. 11. The user u 1102 visits a namespace n in the REST API for J-RON j. The REST API consults the database U→R 1108 to authenticate u, find r(u,j), and then use r(u,j) to find N(C(j)) in the database R→N 1114. To this end, the REST API grants the access only if nεN(C(j)).

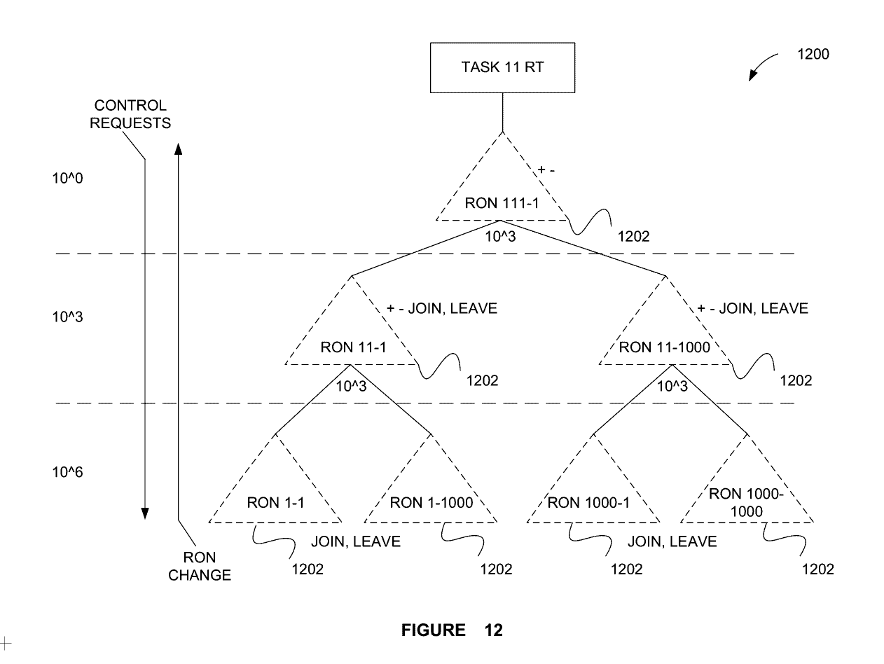

FIG. 12 illustrates a technique 1200 for scaling a job and cluster RON with hierarchy, in accordance with one embodiment. As an option, the technique 1200 may be implemented in the context of any one or more of the embodiments set forth in any previous and/or subsequent figure(s) and/or description thereof. Of course, however, the technique 1200 may be implemented in the context of any desired environment.

As shown, the technique 1200 allows a large underlying system (e.g. cloud, etc.) to be broken up into a corresponding plurality of RONs 1202 which may, in turn, be aggregated for the purposes of controlling access to the underlying system.

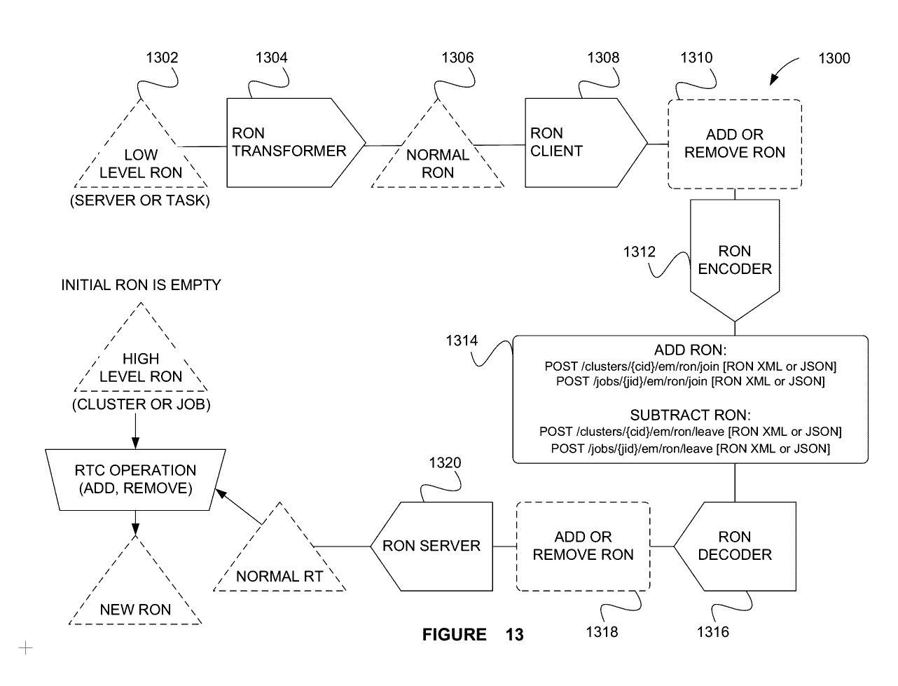

FIG. 13 illustrates a technique 1300 for synchronizing a high-level RON with a low-level RON, in accordance with one embodiment. As an option, the technique 1300 may be implemented in the context of any one or more of the embodiments set forth in any previous and/or subsequent figure(s) and/or description thereof. Of course, however, the technique 1300 may be implemented in the context of any desired environment.

As shown, a low-level RON 1302 is the subject of a RON transformation 1304 to normalize into a normal RON 1306 before being served to a RON client 1308. As indicated in operation 1310, it is determined whether a RON is to be added or removed, in which case a RON encoder 1312 may add or subtract a RON in 1314 and the output can be decoded via a RON decoder 1316 that adds/removes the RON in operation 1318 in a manner that may be made available via a RON server 1320. The addition operator merges multiple low-level RONs into a single high-level RON based on the reference counting technique, while the subtraction operator reduces the high-level RON when the low-level RON becomes unavailable.

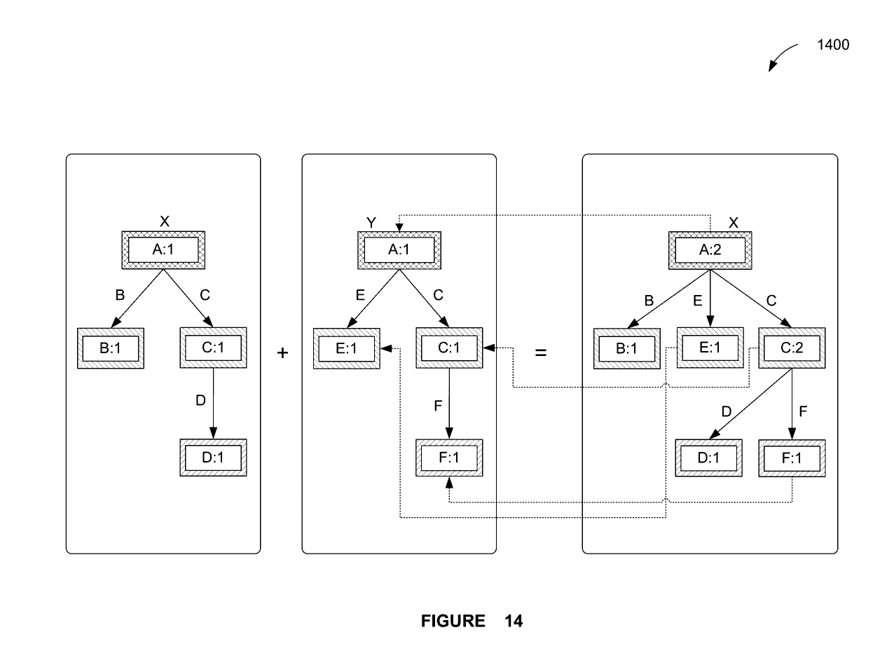

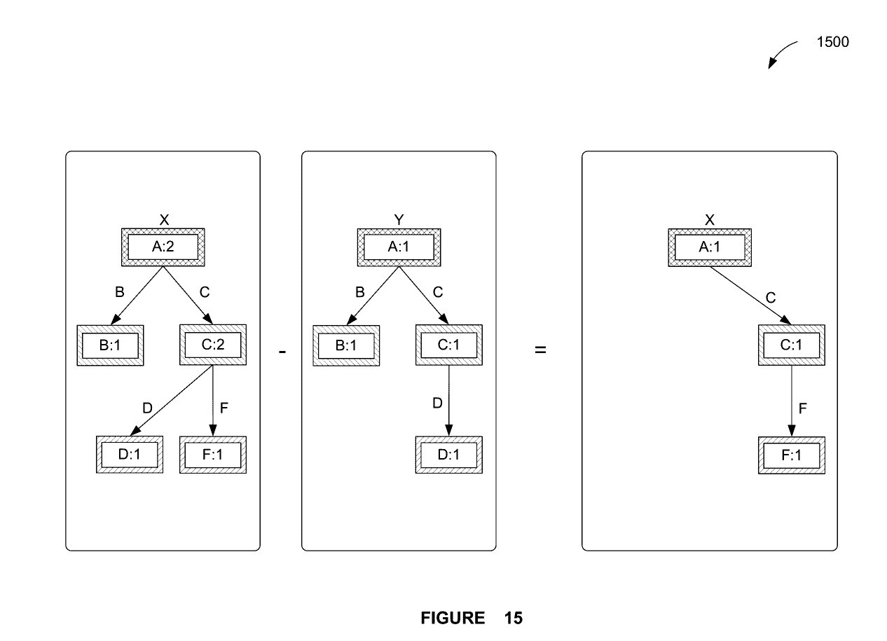

FIGS. 14 and 15 show exemplary addition and subtraction RONs 1400/1500, in accordance with various embodiments. As shown in FIG. 14, subtree B remains under A, subtree E is added under A, node C remains under A, node D remains under A/C, node F is added under A/C. Further, RON X gains new REST services E and D from RON Y's join. As shown in FIG. 15, a subtree B is removed because its rc=0 and node D is removed because its rc=0. Further, RON X loses REST services B and D from RON Y's departure.

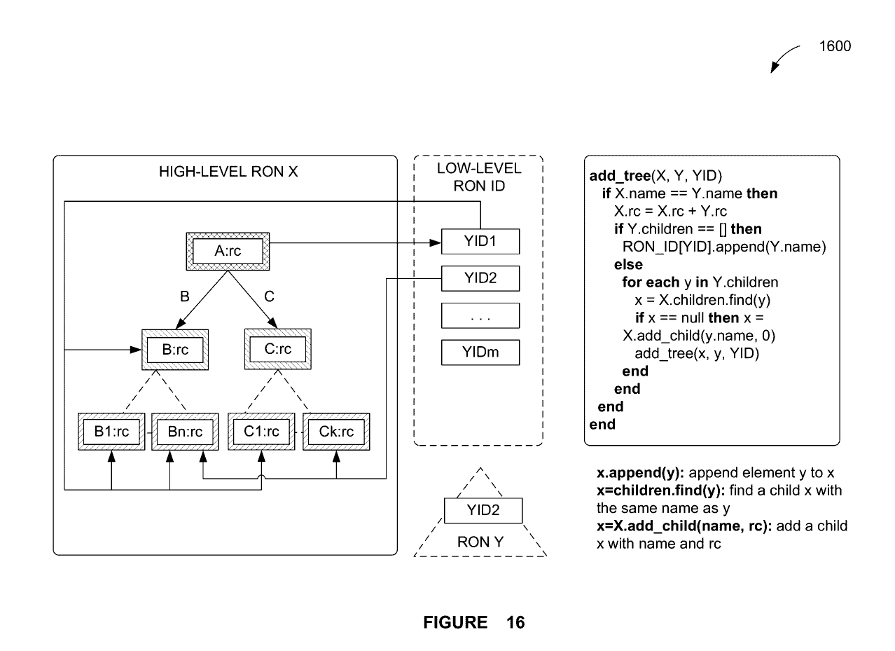

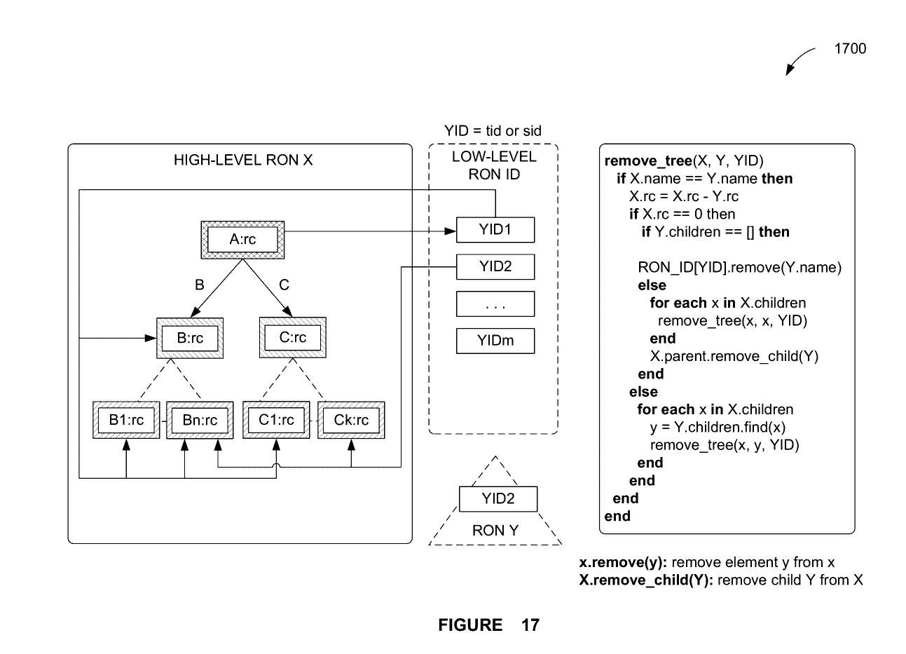

FIG. 16 shows an exemplary RON addition algorithm 1600, in accordance with another embodiment. RON_ID is a data structure (e.g. map or array) that stores the YID (e.g. task id or server id) and pointers to leaves (parameters) of RON X if the RON with YID (e.g. RON Y) includes those leaves. The RON addition operator is: Associative: X+(Y+Z)=(X+Y)+Z and Commutative: X+Y=Y+X. FIG. 17 shows an exemplary RON subtraction algorithm 1700, in accordance with another embodiment.

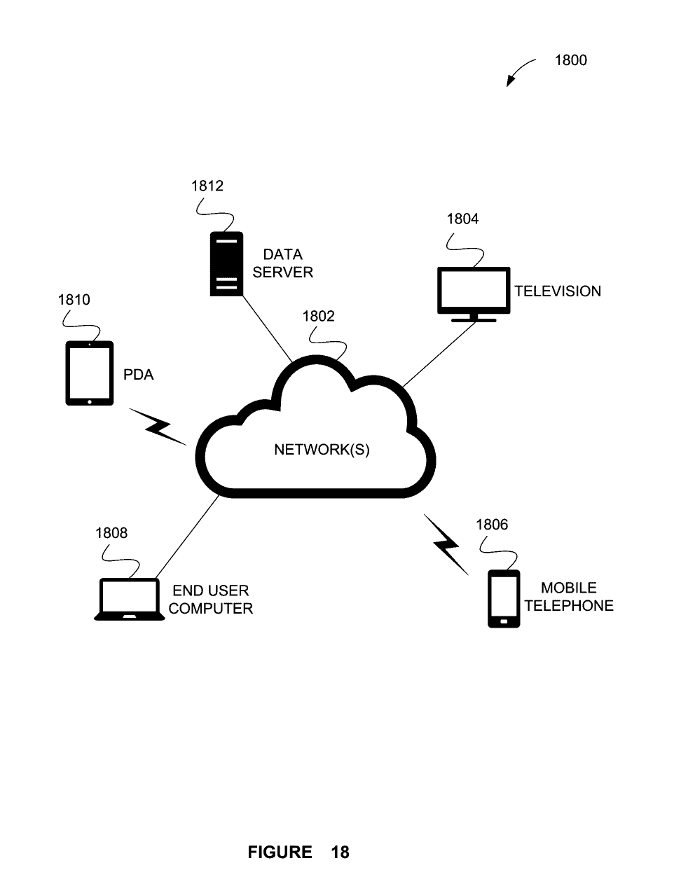

FIG. 18 illustrates a network architecture 1800, in accordance with one possible embodiment. As shown, at least one network 1802 is provided. In the context of the present network architecture 1800, the network 1802 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 1802 may be provided.

Coupled to the network 1802 is a plurality of devices. For example, a server computer 1804 and an end user computer 1806 may be coupled to the network 1802 for communication purposes. Such end user computer 1806 may include a desktop computer, lap-top computer, and/or any other type of logic. Still yet, various other devices may be coupled to the network 1802 including a personal digital assistant (PDA) device 1808, a mobile phone device 1810, a television 1812, etc.

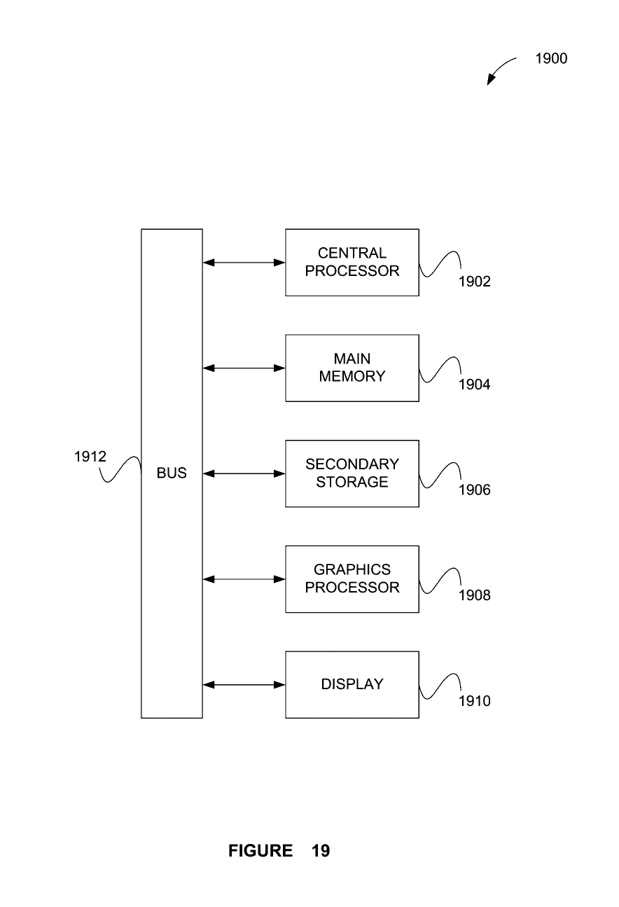

FIG. 19 illustrates an exemplary system 1900, in accordance with one embodiment. As an option, the system 1900 may be implemented in the context of any of the devices of the network architecture 1800 of FIG. 18. Of course, the system 1900 may be implemented in any desired environment.

As shown, a system 1900 is provided including at least one central processor 1901 which is connected to a communication bus 1902. The system 1900 also includes main memory 1904 [e.g. random access memory (RAM), etc.]. The system 1900 also includes a graphics processor 1906 and a display 1908.

The system 1900 may also include a secondary storage 1910. The secondary storage 1910 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 1904, the secondary storage 1910, and/or any other memory, for that matter. Such computer programs, when executed, enable the system 1900 to perform various functions (as set forth above, for example). Memory 1904, storage 1910 and/or any other storage are possible examples of tangible computer-readable media.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), and the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A computer program product embodied on a non-transitory computer readable medium, comprising:
code for receiving a request for a first resource;
code for, in response to receipt of the request for the first resource, identifying a resource-oriented network mapping;
code for identifying a second resource based on the resource-oriented network mapping;
code for accessing the second resource; and
code for generating a response, based on the accessing of the second resource.

2. The computer program product of claim 1, wherein the computer program product is configured such that the first resource includes a representational state transfer (REST) resource.

3. The computer program product of claim 1, wherein the computer program product is configured such that the first resource includes at least one of a task, a job, a server, or a cluster.

4. The computer program product of claim 1, wherein the computer program product is configured such that the second resource includes a control group resource.

5. The computer program product of claim 1, wherein the computer program product is configured such that the second resource includes at least one of a processor, a memory, a storage, or a network component.

6. The computer program product of claim 1, wherein the computer program product is configured such that a plurality of the second resources are identified based on the resource-oriented network mapping, in response to receipt of the request for the first resource.

7. The computer program product of claim 1, wherein the computer program product is configured such that the request is associated with a uniform resource identifier.

8. The computer program product of claim 1, wherein the computer program product is configured such that the first resource is connected to at least one other first resource via at least one hyperlink.

9. The computer program product of claim 1, wherein the computer program product is configured such that the request utilizes a model involving a resource-oriented network.

10. The computer program product of claim 9, wherein the computer program product is configured such that the resource-oriented network includes a tree with at least one parent node and at least one child node.

11. The computer program product of claim 9, wherein the computer program product is configured such that the resource-oriented network decouples a data plane, a control plane, and a representation plane.

12. The computer program product of claim 11, wherein the computer program product is configured such that the data plane includes the second resource.

13. The computer program product of claim 11, wherein the computer program product is configured such that the control plane includes the first resource.

14. The computer program product of claim 11, wherein the computer program product is configured such that the representation plane includes at least one of a hypertext- or a hyperlink-based relation among a plurality of the first resources.

15. The computer program product of claim 1, wherein the computer program product is configured such that the resource-oriented network mapping maps the first resource to the second resource.

16. The computer program product of claim 1, and further comprising:
code for scanning a file system;
code for discovering the second resource, based on the scanning; and
code for populating the resource-oriented network mapping with the discovered second resource.

17. The computer program product of claim 1, wherein the computer program product is configured such that the resource-oriented network mapping enables satisfaction of the request irrespective of changes in an underlying system that includes the second resource.

18. The computer program product of claim 1, wherein the computer program product is configured such that the resource-oriented network mapping is capable of being synchronized based on changes in an underlying system that includes the second resource.

19. The computer program product of claim 18, wherein the computer program product is configured such that the synchronization is performed utilizing at least one of an addition operator or a subtraction operator.

20. A method, comprising:
receiving a request for a first resource;
in response to receipt of the request for the first resource, identifying a resource-oriented network mapping in a storage;
identifying a second resource based on the resource-oriented network mapping;
accessing the second resource; and
generating a response utilizing at least one processor, based on the accessing of the second resource.

21. A system, comprising:
at least one processor configured for:
receiving a request for a first resource;
in response to receipt of the request for the first resource, identifying a resource-oriented network mapping;
identifying a second resource based on the resource-oriented network mapping;
accessing the second resource; and
generating a response, based on the accessing of the second resource.

22. The system of claim 21, wherein the system is configured such that the request utilizes a model involving a resource-oriented network.

23. The system of claim 22, wherein the system is configured such that the resource-oriented network includes a tree with at least one parent node and at least one child node.

24. The system of claim 22, wherein the system is configured such that the resource-oriented network decouples a data plane, a control plane, and a representation plane.

25. The system of claim 24, wherein the system is configured such that the data plane includes the second resource.

26. The system of claim 24, wherein the system is configured such that the control plane includes the first resource.

27. The system of claim 24, wherein the system is configured such that the representation plane includes at least one of a hypertext- or a hyperlink-based relation among a plurality of the first resources.

28. The system of claim 21, wherein the system is configured such that the resource-oriented network mapping maps the first resource to the second resource.

29. The system of claim 21, wherein the at least one processor is further configured for:
scanning a file system;
discovering the second resource, based on the scanning; and
populating the resource-oriented network mapping with the discovered second resource.

30. The system of claim 21, wherein the system is configured such that the resource-oriented network mapping enables satisfaction of the request irrespective of changes in an underlying system that includes the second resource.
